(19) United States
(12) Patent Application Publication
(10) Pub. No.: US 2018/0123227 A1
(43) Pub. Date: May 3, 2018

(54) Power Transmitting Antenna and Method of Production

(71) Applicant: Hoi Luen Electrical Manufacturer Company Limited, Shatin (HK)

(72) Inventor: Yat Ming Ku, Shatin (HK)

(73) Assignee: Hoi Luen Electrical Manufacturer Company Limited

(21) Appl. No.: 15/338,518

(22) Filed: Oct. 31, 2016

(51) Int. Cl. H01Q 1/38; H02J 50/10

(52) U.S. Cl. CPC H01Q 1/38; H02J 50/10

(57) ABSTRACT

A power transmitting antenna (20, 30) is disclosed as including a flexible elongate polymer core (22, 32a) and a length of copper strip or wire (23, 33a) wound on, around and along the elongate core to form an electrically conductive layer (24, 34a) on, around and along the elongate core. A method of producing a power transmitting antenna (20, 30) is disclosed as including steps (a) providing a flexible elongate polymer core (22, 32a), and (b) winding a length of a copper wire or strip (23, 33a) on, around and along the elongate core to form an electrically conductive layer (24, 34a) on, around and along the elongate core.

This invention relates to a power transmitting antenna suitable for, though not limited to, the purpose of wireless charging.

### BACKGROUND OF THE INVENTION

A high operating frequency of 6.78 MHz has been chosen by the Alliance For Wireless Power (A4WP) and Power Matters Alliance (PMA) (now merged with each other and known as AirFuel Alliance) for a new wireless charging interface standard, known as Rezence, with a view to eliminating or at least reducing overheating problem during charging. Under this requirement, wireless charging antenna can only use copper rod or printed circuit board (PCB) technologies through semiconductor to transmit the electric power signals.

It is known that there is a tendency of an alternating electric current (AC) to become distributed within a conductor such that the current density is largest near the surface of the conductor, and decreases with greater depths in the conductor. The electric current flows mainly at the “skin” of the conductor, between the outer surface and a level called the “skin depth”. This “skin effect” causes the effective resistance of the resistance of the conductor to increase at higher frequencies where the skin depth is smaller, thus reducing the effective cross section area of the conductor. At 60 Hz in copper (abbreviated as “copper @60 Hz”), the skin depth is about 8.5 mm. At higher frequencies, the skin depth becomes much smaller. Electrical resistance is a key factor in reducing wireless charging efficiency. To lower the electrical resistance, both the skin effect and the proximity effect should be reduced. The skin effect plays an important role in high frequency application in terms of electrical resistance.

FIG. 1 shows a typical conductor 10 in a resonator, being a solid copper wire 12. The effective cross section area of such a copper wire 12 when operating at a frequency of 6.78 MHz (abbreviated as “@ 6.78 MHz”) is:

$${( \frac{D}{2} )}^{2} π - {( \frac{D}{2} - δ )}^{2} π = ( D δ - {δ}^{2} ) π$$

where D is the outer diameter of the copper wire 12, and

δ is the skin depth of copper @ 6.78 MHz.

As δ is typically very small, the term δ²π may be ignored, to give the approximate value of the effective cross section area of the copper wire 12 @ 6.78 MHz as Dδπ, which in effect is the product of the outer circumference of the copper wire 12 (Dπ) and the skin depth (δ).

It is known that the skin depth of copper @ 6.78 MHz is 0.025 mm. Thus, the effective cross section area of a copper wire of a diameter of 1.6 mm @ 6.78 MHz is approximately 1.6 mm×0.025 mm×π, i.e. about 0.1256 mm².

Because the interior of a large conductor carries so little of the electric current, tubular conductors such as pipes can be used for saving weight and cost. Ideally, one may use copper tubes with a thickness of, say, 0.03 mm to 0.15 mm. However, it is technically very difficult (if at all possible) to manufacture copper tubes of such a small size. Neither is electroplating able to provide consistent and acceptable result. Litz wire is only effective up to a frequency of 3 MHz only, and the proximity effect accompanying the use of Litz wire also off-sets the skin effect. Thus, Litz wire is not suitable for use in applications with an operating frequency of over 3 MHz.

It is thus an object of the present invention to provide a power transmitting antenna and a method of producing such a power transmitting antenna in which the aforesaid shortcomings are mitigated or at least to provide a useful alternative to the trade and public.

### SUMMARY OF THE INVENTION

According to a first aspect of the present invention, there is provided a power transmitting antenna including at least one elongate core made of an electrically non-conductive material, and a first length of electrically conductive material wound on, around and along said elongate core to form a first electrically conductive layer on, around and along said elongate core.

According to a second aspect of the present invention, there is provided a method of producing a power transmitting antenna, including steps (a) providing at least one elongate core made of an electrically non-conductive material, and (b) winding a first length of electrically conductive material on, around and along said elongate core to form a first electrically conductive layer on, around and along said elongate core.

### BRIEF DESCRIPTION OF THE DRAWINGS

Embodiments of the present invention will now be described, by way of examples only, with reference to the accompanying drawings, in which:

FIG. 1 is a transverse cross sectional view of a conventional conductor,

FIG. 2 is a transverse cross sectional view of a power transmitting antenna according to an embodiment of the present invention,

FIG. 3 is a longitudinal cross sectional view of the power transmitting antenna of FIG. 2, and

FIG. 4 is a transverse cross sectional view of a power transmitting antenna according to a further embodiment of the present invention.

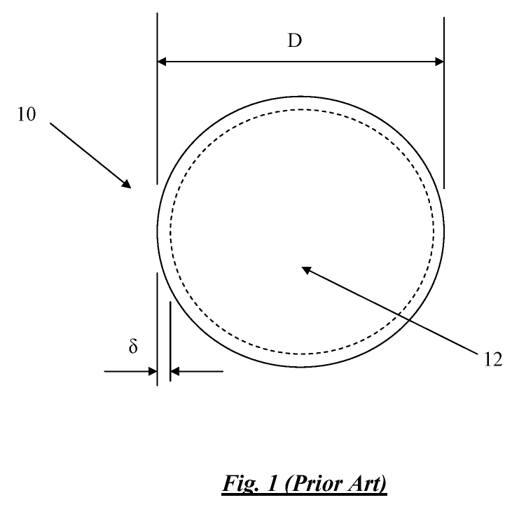

### DETAILED DESCRIPTION OF THE EMBODIMENTS

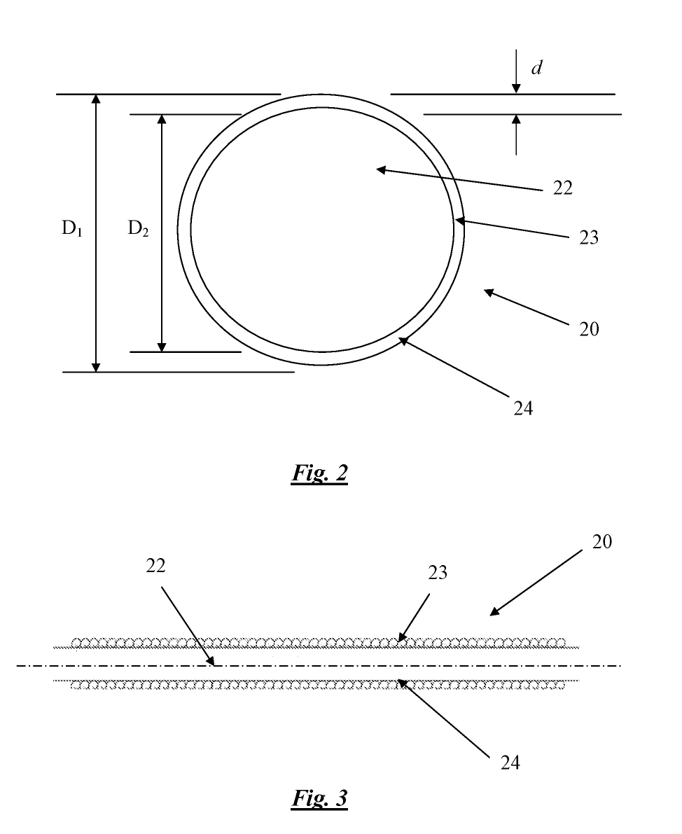

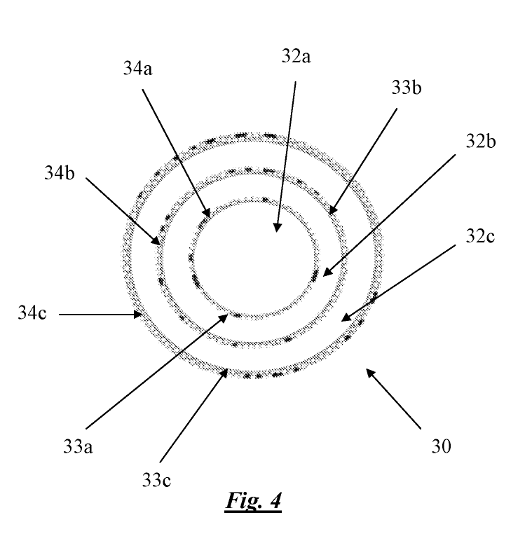

Referring firstly to FIGS. 2 and 3, such show, respectively, a transverse cross sectional view of a power transmitting antenna according to an embodiment of the present invention, generally designated as 20, and a longitudinal cross sectional view of the power transmitting antenna 20. The power transmitting antenna 20 includes a flexible and elongate core 22 of a diameter D₂ of from 0.5 mm to 3 mm (e.g. 0.8 mm), which is made of an electrically non-conductive material, such as a polymer, e.g. a synthetic polymer. A length of electrically conductive material 23, such as a metal (e.g. a copper strip or copper wire), is wound on, around and along the polymer core 22 to form an electrically conductive layer 24 on, around and along the polymer core 22. The electrically conductive layer 24 is of a thickness d

$$( which is equal to \frac{{D}_{1} - {D}_{2}}{2} )$$

of from 0.03 mm to 0.15 mm, such as 0.05 mm, where D₁ is the outer diameter of the power transmitting antenna 20. The length of electrically conductive material is longer than needed to complete the winding onto the core so that it has a length at least sufficiently long to extend to a connection to a source of electrical power for wireless charging. The length of electrically conductive material may have any appropriate cross-section such as a circular cross-section for the length of material as illustrated in FIG. 3. Other cross sections are possible such as but not limited to non-circular rounded shapes such as ellipses or ovals, flattened strip or tape rectangular cross-sections, or combinations thereof, such as stadium/discorectangle/obround shapes.

In order to fully utilize the electrically conductive layer 24 for transmission of electrical signals, the thickness d of the electrically conductive layer 24 is chosen to be double that of the skin depth of the electrically conductive material operating at the intended frequency. As only one layer of the length of electrically conductive material 23 is wound on, around and along the polymer core 22 to form the electrically conductive layer 24, the length of electrically conductive material 23 is thus also of a thickness which is double that of the skin depth of the electrically conductive material operating at the intended frequency. For example, when it is intended to operate the power transmitting antenna 20 at a frequency of 6.78 MHz, the thickness d of the electrically conductive layer 24 is set at 0.05 mm, which is double the skin depth of 0.025 mm of copper @ 6.78 MHz.

By way of such an arrangement, electric currents (and thus electrical signals) may flow through both the inner and outer surfaces of the electrically conductive layer 24, the outer surface being the surface of the electrically conductive layer 24 closer to the outside environment and the inner surface being the surface of the electrically conductive layer 24 closer to the polymer core 22. Thus, the entire cross section area of the electrically conductive layer 24 is used for transmission of electrical signals. In this case, the cross sectional area of the electrically conductive layer 24 is (D₁d−d²) π, where d is double the skin depth of the electrically conductive material (e.g. copper) @ 6.78 MHz.

It can be seen in FIG. 3 that successive turns of the length of electrically conductive material 23 wound on, around and along the polymer core 22 are closely packed with one another (i.e. successive turns of the length of electrically conductive material 23 are in close contact with one another), and that only one layer of the length of electrically conductive material 23 is wound on, around and along the polymer core 22 to form the electrically conductive layer 24. The thickness d of the electrically conductive layer 24 is thus the thickness of the length of electrically conductive material 23.

A transverse sectional view of a further embodiment of a power transmitting antenna according to the present invention is shown in FIG. 4. The power transmitting antenna shown in FIG. 4, generally designated as 30, includes a central flexible elongate core 32a made of an electrically non-conductive material, such as a polymer. A first length of electrically conductive material 33a, such as copper, is wound on, around and along the polymer core 32a to form an electrically conductive layer 34a on, around and along the polymer core 32a. A layer of electrically non-conductive material 32b is formed on the electrically conductive layer 34a. A second length of electrically conductive material 33b, such as copper, is wound on, around and along the layer of electrically non-conductive material 32b to form an electrically conductive layer 34b on, around and along the layer of electrically non-conductive material 32b. A further layer of electrically non-conductive material 32c is formed on the electrically conductive layer 34b. A third layer of electrically conductive material 33c, such as copper, is wound on, around and along the layer of electrically non-conductive material 32c to form an electrically conductive layer 34c on, around and along the layer of electrically non-conductive material 32c. Still further layers of electrically non-conductive material and electrically conductive layers may be formed on the power transmitting antenna 30, if thought necessary. Each of the electrically conductive layers 34a, 34b, 34c provides effectively a conductor with a “skin depth” allowing flow of electrical signals therethrough and reducing electrical resistance.

Such an arrangement is suitable for use as a conductor for high frequency power transmitting resonator to generate magnetic flux for wireless charging applications. The power transmitting antennae according to the present invention optimize the skin effect and proximity effect at high frequency application. While the present invention down-sizes the conductor, reduces the use of electrically conductive materials (e.g. copper), and increases the flexibility of the final product, the electrical performance is maintained.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A power transmitting antenna including:
at least one elongate core made of an electrically non-conductive material, and
a first length of electrically conductive material wound on, around and along said elongate core to form a first electrically conductive layer on, around and along said elongate core.

2. The power transmitting antenna of claim 1, wherein said elongate core is of a diameter of substantially 0.5 mm to 3 mm.

3. The power transmitting antenna of claim 1, wherein said first electrically conductive layer is of a thickness which is substantially double that of the skin depth of said electrically conductive material when operating at a pre-set frequency.

4. The power transmitting antenna of claim 1, wherein said first electrically conductive layer is of a thickness of substantially 0.03 mm to 0.15 mm.

5. The power transmitting antenna of claim 1, wherein said elongate core is made of a polymer.

6. The power transmitting antenna of claim 1, wherein successive turns of said first length of electrically conductive material wound on, around and along said elongate core are closely packed with one another, and wherein the thickness of said first electrically conductive layer is the thickness of said first length of electrically conductive material.

7. The power transmitting antenna of claim 1, wherein said power transmitting antenna is adapted for wireless charging.

8. The power transmitting antenna of claim 1, wherein said power transmitting antenna is adapted to transmit electrical signals at a frequency of substantially 6.78 MHz.

9. The power transmitting antenna of claim 1, including at least a first layer of non-conductive material on and around said first electrically conductive layer, and a second length of electrically conductive material wound on, around and along said first layer of non-conductive material to form a second electrically conductive layer on, around and along said first layer of non-conductive material.

10. A method of producing a power transmitting antenna, including steps:
(a) providing at least one elongate core made of an electrically non-conductive material, and
(b) winding a first length of electrically conductive material on, around and along said elongate core to form a first electrically conductive layer on, around and along said elongate core.

11. The method of claim 10, wherein said elongate core is of a diameter of substantially 0.5 mm to 3 mm.

12. The method of claim 10, wherein said first electrically conductive layer is of a thickness which is substantially double that of the skin depth of said electrically conductive material when operating at a pre-set frequency.

13. The method of claim 10, wherein said first electrically conductive layer is of a thickness of substantially 0.03 mm to 0.15 mm.

14. The method of claim 10, wherein said elongate core is made of a polymer.

15. The method of claim 10, wherein in said step (b), successive turns of said first length of electrically conductive material wound on, around and along said elongate core are closely packed with one another, and wherein the thickness of said first electrically conductive layer is the thickness of said first length of electrically conductive material.

16. The method of claim 10, further including steps:
(c) forming at least a first layer of non-conductive material on and around said first electrically conductive layer, and
(d) winding a second length of electrically conductive material on, around and along said first layer of non-conductive material to form a second electrically conductive layer on, around and along said first layer of non-conductive material.
